(19) United States
(12) Patent Application Publication
(10) Pub. No.: US 2005/0192196 A1
(43) Pub. Date: Sep. 1, 2005

(54) Liquid detergent composition for use with a foam-generating dispenser

(76) Inventors: Howard David Hutton III, Oregonia, OH (US); Bernard Frans De Ryck, Putte (BE); Peter Robert Foley, Cincinnati, OH (US); Kevin George Goodall, Tervuren (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/053,783

(22) Filed: Feb. 9, 2005

Related U.S. Application Data
(60) Provisional application No. 60/543,292, filed on Feb. 10, 2004.

(51) Int. Cl. C11D 1/00

(52) U.S. Cl. 510/337

(57) ABSTRACT

A liquid detergent composition for use with a foam-generating dispenser contains from about 10% to about 90% of a surfactant, from about 10% to about 70% of a solvent, and the balance adjunct detergent ingredients. The liquid detergent composition has a viscosity at 5° C. of less than about 0.15 Pa*s, a viscosity-temperature slope of more than about −0.008 Pa*s/° C. and also has a flash point of at least about 40° C.

### CROSS REFERENCE TO RELATED APPLICATION

This application claims the benefit of U.S. Provisional Application No. 60/543,292, filed Feb. 10, 2004.

### FIELD OF THE INVENTION

The present invention relates to liquid detergent compositions. Specifically, the present invention relates to liquid detergent compositions which are to be used with a foam-generating dispenser.

### BACKGROUND OF THE INVENTION

Liquid detergent compositions are well-known for use in cleaning items such as laundry, dishes, hard surfaces, hair, human and other types of skin, etc. Such compositions typically include a surfactant, and a solvent, and posses a viscosities which can range from extremely thin, such as dilute alcohol-based cleaning compositions to paste and gel-type cleaning compositions.

In addition, for consumer products, it is well-known that for safety reasons, it is preferable to have a high flash point so as to reduce the chance of unintended ignition of possibly volatile compositions. In other cases, however, volatile compositions are desirable, preferred or even essential due to the solvent properties therein. Typically the flash point has been looked at in isolation, merely as a final check prior to sale of commercial detergent compositions.

It has now surprisingly been found that it is desirable to provide a liquid detergent composition in a foam-generating dispenser, and especially a non-aerosol and non-trigger-type foam-generating dispenser. However, it has now been found that many foam-generating dispensers are unable to successfully create a foam from a large range of viscosities. Thus, it has now been found that a liquid detergent composition having a certain viscosity-temperature profile provides significantly superior and consistent results. Furthermore, it has now been found that while it is easy to lower the viscosity by adding a volatile and thin solvent such as ethanol, this results in an unacceptable flash point for many cleaning processes, especially home cleaning processes. Conversely, other compositions having the desired flash point, typically do not possess an acceptable viscosity-dilution profile. Therefore, it has now been recognized that in order to provide an acceptable and safe liquid detergent product in a foam-generating dispenser, it is especially beneficial to design a liquid detergent composition from the beginning taking into account both viscosity limitations as a function of temperature as well as flash point considerations. Such a liquid detergent composition possesses significant benefits when employed with a foam-generating dispenser.

Accordingly, the need exists for a liquid detergent composition which possesses both an acceptable viscosity-temperature profile as well as an acceptable flash point.

### SUMMARY OF THE INVENTION

The present invention relates to a liquid detergent composition for use with a foam-generating dispenser which contains from about 10% to about 90% of a surfactant, from about 10% to about 70% of a solvent, and the balance adjunct detergent ingredients. The liquid detergent composition has a viscosity at 5° C. of less than about 0.15 Pa*s, a viscosity-temperature slope of more than about −0.008 Pa*s/° C. and also has a flash point of at least about 40° C.

It has now been found that such a liquid detergent composition may more easily generate foam at a variety of typical use conditions, while concurrently remaining safe for use in areas adjacent to an open flame, such as a kitchen sink, and/or a kitchen countertop. Such compositions therefore balance both concerns and more consistently, readily and easily generate foam from a foam-generating dispenser than compositions which do not have the discussed viscosity-temperature slope and flash point profiles.

### DETAILED DESCRIPTION OF THE INVENTION

All percentages, ratios and proportions herein are by weight of the final liquid detergent composition, unless otherwise specified. All temperatures are in degrees Celsius (° C.) unless otherwise specified.

As used herein, the term “alkyl” means a hydrocarbyl moiety which is straight or branched, saturated or unsaturated. Unless otherwise specified, alkyl moieties are preferably saturated or unsaturated with double bonds, preferably with one or two double bonds. Included in the term “alkyl” is the alkyl portion of acyl groups.

As used herein, the term “comprising” means that other steps, ingredients, elements, etc. which do not affect the end result can be added. This term encompasses the terms “consisting of” and “consisting essentially of”.

As used herein, the term “microemulsion” means a oil-in-water emulsion which has the ability to emulsify oil into non-visible droplets. Such non-visible droplets typically have maximum diameter of less than about 100 angstroms (Å), preferably less than 50 Å as measured by methods known in the art, such as ISO 7027 which measures turbidity at a wavelength of 880 nm. Turbidity measuring equipment is easily available from, for example, Omega Engineering, Inc., Stamford, Conn., U.S.A.

As used herein, the term “protomicroemulsion” means a composition which may be diluted with water to form a microemulsion.

As used herein, the term “liquid crystal composition” means a composition which is in a liquid crystal state or form, and may be clear or lactescent. Liquid crystal compositions are further defined in, for example, U.S. Pat. No. 5,523,013 to Durbut, et. al., published on Jun. 4, 1996.

The liquid detergent composition herein contains from about 10% to about 90% of a surfactant, from about 10% to about 70% of a solvent, and the balance adjunct detergent ingredients. More importantly, the composition has a viscosity at 5° C. of less than about 0.15 Pa*s, a viscosity-temperature slope of less than about −0.008 Pa*s/° C., and a flash point of at least about 40° C. Such a composition may be in the form of a solution, a liquid crystal composition, a microemulsion, and/or a protomicroemulsion as desired. The liquid detergent composition is typically intended as a hard surface cleaning composition, a hand or automatic machine dishwashing composition, a scouring composition, and/or a laundry and fabric care composition, preferably a hard surface cleaning composition, a hand dishwashing composition, and/or a scouring composition, more preferably a hard surface cleaning composition and/or a hand dishwashing composition, and even more preferably a hand dishwashing composition. Furthermore, such a composition is especially for use in combination with a foam-generating dispenser, preferably a non-aerosol and non-trigger-type foam-generating dispenser, such as are known in the art of body washes, shaving, and/or personal toiletries. Without intending to be limited by theory, it is believed that the foam-generating mechanisms of such dispensers specifically provide excellent results when used in combination with the compositions herein.

The surfactants useful herein include anionic surfactants, amphoteric surfactants, cationic surfactants, zwitterionic surfactants, as well as nonionic surfactants, preferably a combination of anionic and nonionic surfactants are employed herein. Surfactants as described herein include those having about 10 or more carbon atoms in the longest alkyl chain and/or alkaryl group. Such surfactants are present at from about 10% to about 90%, preferably from about 15% to about 75%, and more preferably from about 20% to about 60% by weight of the liquid detergent composition.

The anionic surfactant useful herein includes water-soluble salts or acids of the formula ROSO₃M, wherein R preferably is a C₁₀-C₂₀ linear or branched hydrocarbyl, preferably an alkyl or hydroxyalkyl having a C₁₀-C₂₀ alkyl component, more preferably a C₁₀-C₁₄ alkyl or hydroxyalkyl, and M is H or a cation, e.g., an alkali metal cation or ammonium or substituted ammonium, but preferably sodium and/or potassium.

Other suitable anionic surfactants for use herein are water-soluble salts or acids of the formula RO(A)ₘSO₃M wherein R is an unsubstituted linear or branched C₁₀-C₂₀ alkyl or hydroxyalkyl group having a C₁₀-C₂₀ alkyl component, preferably a C₁₂-C₂₀ alkyl or hydroxyalkyl, more preferably C₁₂-C₁₄ alkyl or hydroxyalkyl, A is an ethoxy or propoxy unit, m is greater than zero, typically between about 0.5 and about 5, more preferably between about 0.5 and about 2, and M is H or a cation which can be, for example, a metal cation, ammonium or substituted-ammonium cation. Alkyl ethoxylated sulfates (abbreviated herein as C_{X-Y}EₘS, where X—Y represents the alkyl group chain length, and where m is the same as described above) as well as alkyl propoxylated sulfates are thus preferred herein. Exemplary surfactants are C₁₀-C₁₄ alkyl polyethoxylate (1.0) sulfate, C₁₀-C₁₄ polyethoxylate (1.0) sulfate, C₁₀-C₁₄ alkyl polyethoxylate (2.25) sulfate, C₁₀-C₁₄ polyethoxylate (2.25) sulfate, C₁₀-C₁₄ alkyl polyethoxylate (3.0) sulfate, C₁₀-C₁₄ polyethoxylate (3.0) sulfate, and C₁₀-C₁₄ alkyl polyethoxylate (4.0) sulfate, C₁₀-C₁₈ polyethoxylate (4.0) sulfate. In a preferred embodiment the anionic surfactant is a mixture of alkoxylated, preferably ethoxylated and non-alkoxylated sulfate surfactants. In such a preferred embodiment the preferred average degree of alkoxylation is from about 0.4 to about 0.8.

Other particularly suitable anionic surfactants for use herein are alkyl sulphonates and alkyl aryl sulphonates, including water-soluble salts or acids of the formula RSO₃M wherein R is a C₁₀-C₂₀ linear or branched, saturated or unsaturated alkyl or aryl group, preferably a C₁₀-C₂₀ alkyl or aryl group and more preferably a C₁₀-C₁₄ alkyl or aryl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Also highly preferred are the linear and branched alkyl benzene sulphonates and more preferably linear alkyl benzene sulphonate.

In a further preferred embodiment, the carbon chain of the anionic surfactant comprises one or more alkyl, preferably C₁₋₄ alkyl, branching units. In such a case, the average percentage branching of the anionic surfactant is greater than about 30%, more preferably from about 35% to about 80% and most preferably from about 40% to about 60%, by weight of the anionic surfactant. Such average percentage of branching can be achieved by formulating the composition with one or more anionic surfactants all of which are preferably greater than about 30% branched, more preferably from about 35% to about 80% and most preferably from about 40% to about 60%. Alternatively and more preferably, the composition may comprise a combination of branched anionic surfactant and linear anionic surfactants such that on average the percentage of branching of the total anionic surfactant combination is greater than about 30%, more preferably from about 35% to about 80% and most preferably from about 40% to about 60%.

The amphoteric surfactant herein is a surfactant whose charge changes according to the pH of the composition, and is preferably selected from the various amine oxide surfactants. Amine oxides are semi-polar surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred are amine oxides of the formula: 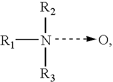
where R₁ is a C₁₀₋₁₄ alkyl and R₂ and R₃ are methyl or ethyl, and those described in U.S. Pat. No. 4,316,824 to Pancheri, granted on Feb. 23, 1982; U.S. Pat. No. 5,075,501 to Borland and Smith, granted on Dec. 24, 1991; and U.S. Pat. No. 5,071,594 to Borland and Smith, granted on Dec. 10, 1991.

Preferred amine oxide surfactants have the formula: 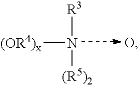
where R³ is an alkyl, a hydroxyalkyl, an alkyl phenyl group or a mixture thereof containing from about 10 to about 22 carbon atoms; R⁴ is an alkylene or hydroxyalkylene group containing from about 2 to about 3 carbon atoms or mixtures thereof; x is from 0 to about 3; and each R⁵ is an alkyl or a hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. Preferred amine oxide surfactants include the C₁₀-C₁₈ alkyl dimethyl amine oxides and the C₁₀-C₁₂ alkoxy ethyl dihydroxy ethyl amine oxides.

Also suitable are amine oxides such as propyl amine oxides, represented by the formula: 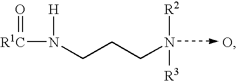
where R¹ is an alkyl, 2-hydroxyalkyl, 3-hydroxyalkyl, or 3-alkoxy-2-hydroxypropyl radical in which the alkyl and alkoxy, respectively, contain from about 10 to about 18 carbon atoms, R² and R³ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula: 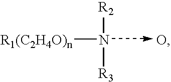
where R₁ is an alkyl, 2-hydroxyalkyl, 3-hydroxyalkyl, or 3-alkoxy-2-hydroxypropyl radical in which the alkyl and alkoxy, respectively, contain from about 10 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10.

Other suitable, non-limiting examples of the amphoteric surfactant useful in the present invention includes amido propyl betaines and derivatives of aliphatic or heterocyclic secondary and ternary amines in which the aliphatic moiety can be straight chain, or branched and wherein one of the aliphatic substituents contains from about 8 to about 24 carbon atoms and at least one aliphatic substituent contains an anionic water-solubilizing group. Further examples of suitable amphoteric surfactants are disclosed in “Surface Active Agents and Detergents” (Vol. I and II by Schwartz, Perry and Berch).

Cationic surfactants useful herein include quaternary ammonium salts having at least one C₁₀-C₁₄ alkyl chain, charge-balanced with an anion, such as chloride. Preferred cationic surfactants include the ammonium surfactants such as alkyldimethylammonium halogenides, and those surfactants having the formula:
[R²(OR³)_{y}][R⁴(OR³)_{y}]₂R⁵N⁺X⁻
wherein R² is an alkyl or alkyl benzyl group having from about 10 to about 18 carbon atoms in the alkyl chain, each R³ is selected from the group consisting of —CH₂CH₂—, CH₂CH(CH₃)—, —CH₃CH(CH₂OH)—, —CH₂CH₂CH₂—, and mixtures thereof; each R⁴ is selected from the group consisting of C₁-C₄ alkyl, C₁-C₄ hydroxyalkyl, benzyl, ring structures formed by joining the two R⁴ groups, —CH₂CHOHCHOHCOR⁶CHOH—CH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Other cationic surfactants useful herein are also described in U.S. Pat. No. 4,228,044, Cambre, issued Oct. 14, 1980, Mono-alkoxylated and di-alkoxylated ammonium salts may also be used herein, and are commonly available from suppliers such as Clariant Corporation, Charlotte N.C., USA and Akzo Nobel nv, Arnhem, the Netherlands.

Zwitterionic surfactants may also be useful herein and can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 Laughlin, et al., issued Dec. 30, 1975 at column 19, line 38 through column 22, line 48 for examples of zwitterionic surfactants. Zwitterionic surfactants particularly useful herein include commonly-available betaine surfactants, particularly lauryl amido propyl betaine, C₁₂-C₁₆ cocoamido propyl betaine, and a mixture thereof.

Nonionic surfactants useful herein are generally disclosed in U.S. Pat. No. 3,929,678 to Laughlin, et al., issued Dec. 30, 1975, at column 13, line 14 through column 16, line 6. Other nonionic surfactants useful herein include the condensation products of aliphatic alcohols with from about 1 to about 25 moles of ethylene oxide. The alkyl chain of the aliphatic alcohol can either be straight or branched, primary or secondary, and generally contains from about 10 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include TERGITOL® 15-S-9 (the condensation product of C₁₁-C₁₅ linear secondary alcohol with 9 moles ethylene oxide), TERGITOL® 24-L-6 NMW (the condensation product of C₁₂-C₁₄ primary alcohol with 6 moles ethylene oxide with a narrow molecular weight distribution), both marketed by Union Carbide Corporation; NEODOL® 45-9 (the condensation product of C₁₄-C₁₅ linear alcohol with 9 moles of ethylene oxide), NEODOL® 23-6.5 (the condensation product of C₁₂-C₁₃ linear alcohol with 6.5 moles of ethylene oxide), marketed by Shell Chemical Company, and KYRO® EOB (the condensation product of C₁₃-C₁₅ alcohol with 9 moles ethylene oxide), marketed by The Procter & Gamble Company, Cincinnati, Ohio, U.S.A. Other commercially available nonionic surfactants include DOBANOL 91-8® marketed by Shell Chemical Co. and GENAPOL UD-080® marketed by Hoechst. This category of nonionic surfactant is referred to generally as “alkyl ethoxylates.”

Also useful herein is a nonionic surfactant selected from the group consisting of an alkyl polyglycoside surfactant, a fatty acid amide surfactant, a C₁₀-C₂₀ ammonia amide, a monoethanolamide, a diethanolamide, an isopropanolamide, and a mixture thereof. Such nonionic surfactants are known in the art, and are commercially-available. A particularly preferred nonionic surfactant useful herein is a C₁₀-C₁₂ alkyl polyglycoside from Cognis Corp. USA, Cincinnati, Ohio. Preferred alkylpolyglycosides have the formula:
R²O(CₙH₂ₙO)ₜ(glycosyl)ₓ,
wherein R² is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants include those having the formula: 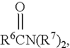
wherein R⁶ is an alkyl group containing from about 10 to about 21 (preferably from about 10 to about 17) carbon atoms and each R⁷ is selected from the group consisting of hydrogen, C₁-C₄ alkyl, C₁-C₄ hydroxyalkyl, and —(C₂H₄O)ₓH where x varies from about 1 to about 3.

Preferred amides are C₁₀-C₂₀ ammonia amides, monoethanolamides, diethanolamides, and isopropanolamides.

The composition herein may comprise up to about 20%, preferably from about 2% to about 10%, of a polyhydroxy fatty acid amide surfactant. If present, the polyhydroxy fatty acid amide surfactant component is typically of the formula: 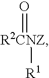
wherein R¹ is H, C₁-C₄ hydrocarbyl, 2-hydroxy ethyl, 2-hydroxy propyl, or a mixture thereof, preferably C₁-C₄ alkyl, more preferably C₁ or C₂ alkyl, even more preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, even more preferably straight chain C₁₁-C₁₅ alkyl or alkenyl, or a mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. R²—C(O)—N< is preferably selected from cocamide, stearamide, oleamide, lauramide, myristamide, capricamide, palmitamide, tallowamide, and a mixture thereof. Z preferably will be derived from a reducing sugar in a reductive amination reaction; more preferably Z will be a glycityl. Suitable reducing sugars include glucose, fructose, maltose, lactose, galactose, mannose, and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂(CHOR′)(CHOH)—CH₂OH, and alkoxylated derivatives thereof, where n is an integer from 3 to 5, inclusive, and R is H or a cyclic or aliphatic monosaccharide. Even more preferred are glycityls wherein n is 4, particularly —CH₂—(CHOH)₄—CH₂OH.

The solvent useful herein is typically selected from the group consisting of water, an alcohol, a glycol, an ether, an ether alcohol, a carbitol, and a mixture thereof, more preferably the group consisting of water, a C₁₋₂₀ glycol, ethanol, a glycol ether including aryl, alkyl, branched, non-branched variants thereof and a mixture thereof, even more preferably the group consisting of propylene carbonate, propylene glycol, tripropyleneglycol n-propyl ether, diethylene glycol n-butyl ether, water, and a mixture thereof. To maintain an appropriate flash point in the final composition, higher flash point solvents are preferred, either alone or in combination with other solvents herein. Accordingly, the solvent herein preferably has a solubility in water of at least about 12%, more preferably of at least about 50%, by weight of the solution. The solvent is typically present at a level of from about 10% to about 70%, preferably from about 15% to about 60%, and more preferably from about 18% to about 55% by weight of the composition.

The balance of the composition contains adjunct detergent ingredients, such as, for example, a low water-soluble oil, a viscosity modifier, a thickener, an enzyme, an antioxidant, a free radical inhibitor, an alkalinity source, a perfume, a dye, a reducing or oxidizing bleach, an odor-control agent such as cyclodextrin, and a mixture thereof, preferably a low water-soluble oil, a thickener, an enzyme, an antioxidant, a free radical inhibitor, and a mixture thereof. Other ingredients known in the art of detergents, and especially dishwashing detergents may also be included herein.

In a preferred embodiment such as a microemulsion and a protomicroemulsion, a low water-soluble oil is typically present at a level of from about 0.25% to about 50%, preferably from about 0.3% to about 45%, and more preferably from about 0.5% to about 35%, by weight of the composition. The low water-soluble oil useful herein has a solubility in water of less than about 5,000 ppm, preferably from about 0 part per million (ppm) to about 1,500 ppm, by weight of the solution, and more preferably from about 1 part per trillion to about 100 ppm. Preferred low water-soluble oils useful herein include terpenes, isoparaffins, other oils having the above solubility, and a mixture thereof. Highly preferred low water-soluble oils useful herein include limonene (CAS # 138-86-3; 13.8 ppm [Massaldi, H. A.; King, C. J.; Simple Technique to Determine Solubilities of Sparingly Soluble Organics—Solubility and Activity Coefficients of D-Limonene, n-Butyl benzene and n-Hexyl Acetate in Water and Sucrose Solutions.; J. Chem. Eng Data; 18(4): 393-397; 1973]), methyl oleate (CAS # 112-62-9; 0.00184 ppm (Krop, H. B., et al.; n-Octanol-Water Partition Coefficients, Aqueous Solubilities and Partition Coefficients, Aqueous Solubilities and Henry's Law Constants of Fatty Acid Esters; Chemosphere; 34:107-119; 1997]), diethyl phthalate (CAS # 84-66-2; 1080 ppm [Howard, P. H., et al.; Measurement of Water Solubilities, Octanol-Water Partition Coefficients and Vapor Pressures of Commercial Phthalate Esters.; Environ. Tox. Chem.; 4:653-61; 1985]), benzyl benzoate (CAS # 120-51-4; 15.4 ppm [Gunther, F. A., et al.; Reported Solubilities of 738 Pesticide chemicals in Water.; Res. Rev.; 20:1-148; 1968]), C>10 isoparaffins (CAS# 64771-71-7; 0.11 ppm [Aulif, K. and Mak, V.; Solubility of Paraffin, Cycloparaffin, Olefin, Acetylene, cycloolefin, and Aromatic Hydrocarbons in Water.; Org. Geokhim.; 2:168-82; 1970]) and a mixture thereof, and even more preferably limonene, terpineol, and a mixture thereof. Such low water-soluble oils are commonly available to those skilled in the art.

Limonene (aka, dipentene; p-mentha-1,8 diene) is especially preferred for use herein, and may be purchased from a variety of chemical suppliers, for example, Sigma-Aldrich Corp., St. Louis, Mo., USA. Without intending to be limited by theory, it is believed that a composition containing d-limonene provides significantly faster speed of oil absorption as well as a significantly higher overall capacity for oil absorption, as compared to isoparaffins and other low-water-soluble oils. In addition, the d-limonene form is easily biodegradable and therefore is highly desirable from an environmental and regulatory standpoint.

Terpineol (aka, 1-Methyl-4-isopropyl-1-cyclohexen-8-ol) is also especially preferred for use herein, and may be purchased from a variety of chemical suppliers, for example, Sigma-Aldrich Corp., St. Louis, Mo., USA. Without intending to be limited by theory, it is believed that a composition containing terpineol also provides significantly faster speed of oil absorption as well as a significantly higher overall capacity for oil absorption, as compared to isoparaffins and other low-water-soluble oils.

In a highly preferred embodiment, the composition herein contains the combination of a glycol ether and a low water-soluble oil, wherein the weight ratio of glycol ether to low water-soluble oil is from about 20:1 to about 1:20, preferably from about 15:1 to about 1:15, and more preferably from about 10:1 to about 1:10. In a particularly preferred embodiment, the glycol ether is selected from the group consisting of C₂₋₆ alkyl glycol ether, aryl C₂₋₆ alkyl glycol ether, and a mixture thereof, more preferably phenyl ethylene glycol ether, phenyl propylene glycol ether, and a mixture thereof. Without intending to be limited by theory, it is believed that this can improve the odor profile of the product, while simultaneously maintaining acceptable kinetics.

In a highly preferred embodiment, the composition contains from about 1% to about 20%, preferably from about 2% to about 16% of a viscosity modifier. The viscosity modifier useful herein is selected from the group consisting of a hydrotrope, naphthalene, and a mixture thereof. Hydrotrope generally means a compound with the ability to increase the solubilities, preferably aqueous solubilities, of certain slightly soluble organic compounds. The hydrotrope herein has a carbon chain length of less than 10 carbon atoms in the longest alkyl chain and/or alkaryl group. As the hydrotrope has such a short alkyl/alkaryl chain length, it is typically considered separate from the class of surfactants, as such a short alkyl/alkaryl chain does not provide sufficient hydrophobicity to sufficiently draw hydrophobic soils into solution. However, without intending to be limited by theory, it has now been surprisingly found that such a short chain length is appropriate to provide hydrotrophic effects which may significantly reduce viscosity. It is believed that surfactant aggregates in the surfactant phase are what result in the high viscosity of compositions having high surfactant levels. Thus, for mixed surfactant systems, it is extremely difficult to predict the complex surfactant interactions of a surfactant system when multiple surfactants are employed therein. However, such viscosity modifiers achieve a viscosity reduction by inserting themselves into the surfactant phase and solubilizing the surfactant aggregates into the solvent. While it is known to reduce viscosity via adding ethanol, the present invention has recognized that such an approach in and of itself is insufficient and less preferred than adding a viscosity modifier, as shown by the correspondingly reduced flash point when ethanol alone is added.

Preferred hydrotropes herein include the alkyl aryl sulphonates or alkyl aryl sulfonic acids. Preferred alkyl aryl sulphonates include: sodium, potassium, calcium and ammonium xylene sulphonates; sodium, potassium, calcium and ammonium toluene sulphonates; sodium, potassium, calcium and ammonium cumene sulphonates; sodium, potassium, calcium and ammonium substituted or unsubstituted naphthalene sulphonates; and mixtures thereof. Preferred alkyl aryl sulfonic acids include xylene sulfonic acid, toluene sulfonic acid, cumene sulfonic acid, substituted or unsubstituted naphthalene sulfonic acid and mixtures thereof. More preferably, cumene sulphonate or p-toluene sulphonate or mixtures thereof are used.

In a preferred embodiment, a thickener known in the art is also present, preferably selected from a xanthan gum, laponite, a fumed silica, a polyvinyl alcohol, a polyacrylic acid, a polyvinyl pyrrolidone, a cellulose, a modified cellulose, a guar gum, a gum arabic and a mixture thereof, preferably a xanthan gum with a molecular weight of approximately 10⁶. Derivatives of xanthan gum can be used provided they retain the anionic side chains and, preferably, hydroxyl groups. If present, a thickener is typically present at from about 0.1% to about 5%, by weight to adjust the composition to the desired viscosity. Thickeners useful herein are found in, for example, U.S. Pat. No. 4,648,987 to Smith and Munk, issued on Mar. 10, 1987; and U.S. Pat. No. 5,106,609 to Bolich, et al., issued on May 12, 1992. Other thickeners useful herein include those described as “water-soluble thickening polymers” in U.S. patent application Ser. No. 10/705,567, filed on Nov. 10, 2003, to Castro, et al. (P&G Ref. No CM2691M).

In a preferred embodiment, an enzyme is also present. The enzyme useful herein includes a cellulase, a hemicellulase, a peroxidase, a protease, a gluco-amylase, an amylase, a lipase, a cutinase, a pectinase, a xylanase, a reductase, an oxidase, a phenoloxidase, a lipoxygenase, a ligninase, a pullulanase, a tannase, a pentosanase, a malanase, a β-glucanase, an arabinosidase and a mixture thereof. A preferred combination is a detergent composition having a cocktail of conventional applicable enzymes such as protease, amylase, lipase, cutinase and/or cellulase. An enzyme is typically present at from about 0.0001% to about 5% of active enzyme, by weight. Preferred proteolytic enzymes are selected from the group consisting of ALCALASE® (Novo Industri A/S), BPN′, Protease A and Protease B (Genencor), and mixtures thereof. Protease B is more preferred. Preferred amylase enzymes include TERMAMYL®, DURAMYL® and the amylase enzymes described in WO 9418314 to Genencor International and WO 9402597 to Novo. Further non-limiting examples of suitable and preferred enzymes are disclosed in WO 99/63034 to Vinson, et al., published on Dec. 9, 1999.

In preferred embodiments, antioxidants and free radical inhibitors, such as BHT (2,6-Di-t-butyl-4-methylphenol), and others known in the art, are included to limit oxidation of active ingredients.

Without intending to be limited by theory, it is believed that the compositions herein typically have a viscosity-temperature curve which, when plotted typically falls within the range shown in Table I, below:

[image]

In Table I and Table II, the viscosity is measured in cps, where 1 Pa*s=1,000 cps. Furthermore, the temperature is measured in ° C.

When such a plot is extrapolated to 0° C. and out to 50° C., a triangular area is formed as described in Table II,

[image]

which is further described by the integral:
∫−3.33*T+166 (dT) (where T is temperature in ° C. from 0-50).

Without intending to be limited by theory, it is believed that a majority of the viscosity-temperature profiles from the compositions herein fall within the above integral. However, as it is recognized that the viscosity will often not reach zero at 50° C., and therefore the preferred integral is:
∫−3.33*T+166 (dT) (where T is temperature in ° C. from 5-20).

As such, the viscosity-temperature profiles for preferred formulations typically fall within the above integral, for the temperature range of from 5° C. to 20° C.

The compositions herein may be formed by methods known in the art, such as simple stirring and mixing in a standard tank or mixer. Alternatively, premelting and emulsification techniques known in the art may also be employed for specific formulations, as desired.

Method of Use

The composition herein is particularly suited for use as a cleaning composition, more preferably as a dishwashing composition, and even more preferably as a hand dishwashing composition with a foam-generating dispenser. Depending upon the ambient temperature, the composition may be used at a wide range of temperatures, for example, from 5° C. or lower in the winter, to even above 40° C. in the summer, depending upon the ambient temperature during use. The invention herein is especially useful in the direct-application context where the composition is applied via a foam-generating dispenser to a substrate such as a sponge, a wiping substrate, a scrubbing substrate, a nonwovern material, etc. Water is usually then added to the substrate to dilute the composition, preferably in or on the substrate itself. The ME is then applied directly or indirectly to a surface to be cleaned, such as a dish, a glass, flatware, etc., and preferably soaked for from about 2 seconds to about 1 hour. Alternatively, the composition may be applied from the dispenser directly onto an item to be cleaned, such as a pan or other hard surface. The surface is then usually rinsed to remove the dirt, soil, and composition and then preferably, dried. Such a method effectively cleans not only dishes, glasses, and flatware, but may also clean kitchen countertops, tile, bathrooms, hardwood floors, and other hard surfaces.

In addition, other methods of use are also useful, such as forming a wash bath by diluting the composition in, for example, a sink or wash basin, contacting the surface to be cleaned with the wash bath, preferably soaked for from about 2 seconds to about 1 hour, and then rinsed to remove the dirt, soil, and composition.

Foam-generating dispensing containers are known in the art, and will typically comprise a hand-held bottle having an aesthetically desirable and/or ergonomic shape, and a dispensing spout, or nozzle through which the composition is passed, emerging as a foam. Preferred foam-generating dispensers useful herein include: T8900, OpAd FO, 8203, and 7512 series foamers from Afa-Polytek, Helmond, The Netherlands; T1, F2, and WR-F3 series foamers from Airspray International, Inc., Alkmaar, The Netherlands or North Pompano Beach, Fla., U.S.A.; TS-800 and Mixor series foamers from Saint-Gobain Calmar, Inc., City of Industry, Calif., U.S.A.; pump foamers and squeeze foamers from Daiwa Can Company, Tokyo, Japan; TS1 and TS2 series foamers from Guala Dispensing USA, Inc., Hillsborough, N.J., U.S.A.; and YT-87L-FP, YT-87L-FX, and YT-97 series foamers from Yoshino Kogyosho Co., Ltd., Tokyo, Japan. Also see the foam-generating dispensers discussed in the Japanese-language publications Food & Package, (2001) vol. 42, no. 10, pp 609-13; Food & Package, (2001) vol. 42, no. 11, pp 676-79; and Food & Package, (2001) vol. 42, no. 12, pp 732-35. Variations and modifications of existing foam-generating dispensers are especially useful herein, especially by modifying air piston:product piston volume ratio, mesh/net sizes, impinging angle, etc., as well as optimization of the sizes and dimensions of the cylinder, rod, dip tube, nozzle, etc.

Test Methods:

The viscosity herein is measured on a Brookfield viscometer model # LVDVII+at 5° C. and at 20° C. These specific temperatures and the range therein were chosen as they are believed to representatively cover a majority of the temperature range at which a typical product will be used. While it is recognized that most compositions will get more viscous as the temperature drops, this may not always be the case. A temperature-controlled water jacket is employed around the test sample to maintain a constant temperature during the viscosity measurements. The spindle used for these measurements is a S31 spindle with the appropriate speed to measure products of different viscosities; e.g., 12 rpm to measure products of viscosity greater than 1 Pa*s; 30 rpm to measure products with viscosities between 0.5 Pa*s−1 Pa*s; 60 rpm to measure products with viscosities less than 0.5 Pa*s. The viscosity of the sample is measured three times and the viscosity for the given temperature is calculated as the average of these three measurements. The invention herein typically has an viscosity at 5° C. of less than about 0.15 Pa*s, preferably from about 0.15 Pa*s to about 0.0001 Pa*s, more preferably at least about 0.001 Pa*s to about 0.1 Pa*s, even more preferably from about 0.005 Pa*s to about 0.08 Pa*s, and still even more preferably from about 0.01 Pa*s to about 0.06 Pa*s.

The viscosity is then plotted vs. temperature on a line graph, and the slope is calculated between the 5° C. viscosity datapoint and the 20° C. viscosity datapoint, using the following standard slope formula:
viscosity-temperature slope=(5° C. viscosity-20° C. viscosity)/(5° C.-20° C.).

Therefore, the viscosity-temperature slope for the compositions herein is more than about −0.008 Pa*s/° C., preferably form about −0.008 Pa*s/° C. to about 0 Pa*s/° C., more preferably from about −0.006 Pa*s/° C. to about 0 Pa*s/° C., and even more preferably from about −0.004 Pa*s/° C. to about 0 Pa*s/° C.

Furthermore, it is recognized that the liquid composition herein may have a Newtonian or non-Newtonian behavior. However, as long as the viscosity and temperature profiles are as described herein, even non-Newtonian liquids fall within the invention herein.

The flash point of the test sample is defined as the lowest temperature at which a liquid gives off vapor within a test vessel in sufficient concentration to form an ignitable mixture with air near the surface of the liquid. The lower the flash point, the easier it is to ignite the material, while the higher the flash point, the more difficult it is to ignite the material. In the present invention, the flash point is measured using the ASTM D93-02a Pensky-Martens Closed Tester (closed cup) flashpoint method. While the D93-02a method is only specifically intended for 40-360° C., the methodology is also used to measure lower temperature flash points. However, no noticeable datapoint deviations have been observed at temperatures below 40° C., and reproducibility is comparable to that of temperatures above 40° C.

The flash point for the compositions herein is at least about 40° C., more preferably at least about 43° C., and has no upper limit, as anything above these ranges is considered very safe. However, it is recognized that for practical purposes, the flash point will typically be less than about 500° C., and preferably less than about 350° C.

Without intending to be limited by theory, it is believed that the use of a balance of a solvent and low-water soluble oil is especially useful in order to provide the desired balance between viscosity-temperature slope and the flash point.

### EXAMPLE 1

Non-limiting examples of a composition according to the invention are provided below:

| | | | | D |
|---|---|---|---|---|
| | | | C | Comparative |
| | | | Compaarative | Example |
| | | | Example | (Marketed |
| | | | (Marketed | Product) |
| | | B | Product) | Diluted with |
| | | Comparative | Diluted with | 4% Added |
| | A | Example | Water | Ethanol |
| Sodium C₁₂ Alkyl | 26.5 | 26.5 | 18.6 | — |
| Ethoxy_{0.6} Sulfate | | | | |
| C₁₂₋₁₄ Alkyl Dimethyl | 6 | 6 | 4.2 | — |
| Amine Oxide | | | | |
| C₈ Alcohol Ethoxylated | 2 | 2 | 1.4 | — |
| Nonionic surfactant | | | | |
| Poly(dimethylaminometha- | 0.2 | 0.2 | 0.14 | — |
| crylate) | | | | |
| 1,3-bis (methylamine)- | 0.5 | 0.5 | 0.3 | — |
| cyclohexane | | | | |
| Terpineol | 1.5 | — | — | — |
| Solvents/Hydrotropes | | | | |
| Ethanol | 6 | 12 | 6 | — |
| Propylene Glycol | 8 | — | — | — |
| Propyleneglycol phenyl | 11 | — | — | — |
| ether | 4 | 4 | — | — |
| Sodium Cumene Sulfonate | balance | balance | balance | — |
| Water and minors | | | | |
| Viscosity (in Pa*s) | | | | |
| 20° C. | 45 | 50 | 56 | 60 |
| 5° C. | 95 | 130 | 397 | 190 |
| Viscosity-Temperature | −0.0034 | −0.00533 | −0.02273 | −0.00867 |
| Slope (in Pa*s/° C.) | Acceptable | Acceptable | Unacceptable | Unacceptable |
| Flash Point (° C.) | 48 | 35 | >45 | 34 |
| | Acceptable | Unacceptable | Acceptable | Unacceptable |

Composition D, prior to the dilution with 4% ethanol, contained approximately 15% sodium C₁₂₋₁₃ alkyl ethoxy_{2.0} sulfate, 4.6% amine oxide, 12.4% C₁₀₋₁₂ alkyl polyglycoside, 1.6% sodium toluene sulfonate, 6.3% ethanol, 0.3% phosphoric acid, 0.3% limonene, 0.1% citric acid, and the balance water and minor ingredients. As noted, the Composition A representing the invention possesses both an acceptable viscosity-temperature slope and an acceptable flash point, whereas the currently marketed commercial products (Compositions C and D) do not. Both compositions C and D had to be diluted in order to reach a desired viscosity of less than 0.1 Pa*s. Furthermore, even when diluted, the viscosity-temperature slope of Composition C was unacceptable, whereas the flash point of Composition D was unacceptable.

### EXAMPLE 2

A liquid detergent composition similar to composition A in Example 1 was prepared, except that it contained 7% terpineol and 3% propyleneglycol phenyl ether. The viscosity was about 0.045 Pa*s at 20° C. and about 0.11 Pa*s at 5° C., providing an acceptable viscosity-temperature slope of about −0.0043 Pa*s/° C. The flash point was about 48° C.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

1. A liquid detergent composition for use with a foam-generating dispenser comprising:
A. from about 10% to about 90% of a surfactant;
B. from about 10% to about 70% of a solvent; and
C. the balance adjunct detergent ingredients,
wherein the composition has a viscosity at 5° C. of less than about 0.15 Pa*s, wherein the composition has a viscosity-temperature slope of more than about −0.008 Pa*s/° C., and wherein the composition has a flash point of at least about 40° C.

2. The liquid detergent composition of claim 1, wherein the liquid detergent composition is selected from the group consisting of a liquid crystal composition, a microemulsion and a protomicroemulsion.

3. The liquid detergent composition of claim 1, wherein the composition has a flash point of at least about 43° C.

4. The liquid detergent composition of claim 1, wherein the composition has a viscosity-temperature slope of from about −0.008 Pa*s/° C. to about 0 Pa*s/° C.

5. The liquid detergent composition of claim 1, comprising from about 15% to about 60% of a solvent.

6. The liquid detergent composition of claim 1, further comprising from about 1% to about 20% of a viscosity modifying ingredient selected from the group consisting of a hydrotrope, naphthalene, and a mixture thereof.

7. The liquid detergent composition of claim 1, wherein the viscosity at 5° C. is from about 0.001 Pa*s to about 0.1 Pa*s.

8. The liquid detergent composition of claim 4, wherein the composition has a viscosity-temperature slope of from about −0.006 Pa*s/° C. to about 0 Pa*s/° C.

9. The liquid detergent composition of claim 5, wherein the solvent is selected from the group consisting of water, an alcohol, a glycol, an ether, an ether alcohol, a carbitol, and a mixture thereof.

10. A liquid detergent composition for use with a foam-generating dispenser comprising:
A. from about 10% to about 90% of a surfactant;
B. from about 10% to about 70% of a solvent selected from the group consisting of water, an alcohol, a glycol, an ether, an ether alcohol, a carbitol, and a mixture thereof;
C. from about 1% to about 20% of a viscosity modifying ingredient selected from the group consisting of a hydrotrope, naphthalene, and a mixture thereof;
D. from about 0.25% to about 50% of a low water-soluble oil; and
E. the balance adjunct detergent ingredients,
wherein the composition has a viscosity at 5° C. of less than about 0.15 Pa*s, wherein the composition has a viscosity-temperature slope of from about −0.008 Pa*s/° C. to about 0 Pa*s/° C., and wherein the composition has a flash point of from about 40° C. to about 500° C.
